(19) United States
(12) Patent Application Publication
(10) Pub. No.: US 2016/0097888 A1
(43) Pub. Date: Apr. 7, 2016

(54) POLARIZER INCLUDING ANTIGLARE FILM AND DISPLAY APPARATUS INCLUDING THE SAME

(71) Applicant: Samsung Electronics Co., Ltd., Gyeonggi-do (KR)

(72) Inventor: Sil Kyu Lim, Gyeonggi-do (KR)

(21) Appl. No.: 14/876,761

(22) Filed: Oct. 6, 2015

(30) Foreign Application Priority Data
Oct. 6, 2014 (KR) 10-2014-0134459

(51) Int. Cl. G02B 5/30; G02F 1/1333; G02F 1/1335; G02B 1/14

(52) U.S. Cl. CPC G02B 5/305; G02B 1/14; G02F 1/13338; G02F 1/133528; G02F 1/133502

(57) ABSTRACT

A polarizer including a polarization film, a first protection film attached to a bottom surface of the polarization film, a second protection film attached to a top surface of the polarization film, and an antiglare film formed on a top surface of the second protection film, is provided. The antiglare film has a haze value in 3 to 5% and an arithmetic mean deviation of the profile (Ra) of 60 to 100 nm.

### CROSS-REFERENCE TO RELATED APPLICATION AND CLAIM OF PRIORITY

The present application is related to and claims benefit under 35 U.S.C. §119(a) of a Korean patent application filed on Oct. 6, 2014 in the Korean Intellectual Property Office and assigned Serial number 10-2014-0134459, the entire disclosure of which is hereby incorporated by reference.

### TECHNICAL FIELD

The present disclosure relates to a polarizer including an antiglare film and a display apparatus including the polarizer.

### BACKGROUND

In recent years, there is steadily increasing demands for electronic apparatuses, to which touch panels are employed, such as mobile phones, tablet PCs, navigation systems, and so forth. Many studies are also sprightly proceeding to improve those apparatuses. A touch panel is a device that is installed on the surface of a display apparatus and converts a physical contact, such as a user's finger or a touch pen, into an electric signal.

A display apparatus equipped with such a touch panel may include a liquid crystal panel, a polarizer attached to the top of the liquid crystal panel, and a touch panel placed on the polarizer through an air gap. In the configuration, a polarizer to which an antiglare film is attached is used to prevent degradation of display performance that is caused from reflection of light incident from an external source.

Antiglare films applied to a polarizer are diversified in kind, for example, AF films, LR films, AR films, and so forth. Additionally, there are used composite types of those films, for example, AG/LR films, AG/AR films, and so forth. Meanwhile, antiglare films are affected by transmittance, reflectance, haze, surface, illuminance, and so forth.

If pressure is applied to the top of a display apparatus equipped with a touch panel, a polarizer and the touch panel, which are isolated through an air gap, are in contact with each other. In this case, there may be generated a watermark that appears to be an oil belt around the contact area between an antiglare film of the polarizer and the touch panel. Such a watermark may degrade external appearance of a display apparatus.

### SUMMARY

To address the above-discussed deficiencies, it is a primary object to provide at least the advantages described below. Accordingly, various embodiments of the present disclosure provide a polarizer diminishing a watermark and a display apparatus including the polarizer.

In accordance with an aspect of the present disclosure, a polarizer includes a polarization film, a first protection film attached to a bottom surface of the polarization film, a second protection film attached to a top surface of the polarization film, and an antiglare film formed on a top surface of the second protection film, wherein the antiglare film comprises a haze value in 3 to 5% and an arithmetic mean deviation of the profile (Ra) of 60 to 100 nm.

In accordance with another aspect of the present disclosure, a display apparatus includes a liquid crystal panel, a first polarizer attached to a bottom surface of the liquid crystal panel, a second polarizer attached to a top surface of the liquid crystal panel, and a touch panel disposed apart from a top surface of the second polarizer, wherein the second polarizer includes a polarization film, a first protection film attached to a bottom surface of the polarization film, a second protection film attached to a top surface of the polarization film, and an antiglare film formed on a top surface of the second protection film, wherein the antiglare film comprises a haze value in 3 to 5% and an arithmetic mean deviation of the profile (Ra) of 60 to 100 nm.

Other aspects, advantages, and salient features of the present disclosure will become apparent to those skilled in the art from the following detailed description, which, taken in conjunction with the annexed drawing, discloses various embodiments of the present disclosure.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a diagram schematically illustrating a structure of a display apparatus according to an embodiment of the present disclosure; and

FIG. 2 is a diagram schematically illustrating a structure of a second polarizer according to an embodiment of the present disclosure.

Throughout the drawings, it should be noted that like reference numbers are used to depict the same or similar elements, features, and structures.

### DETAILED DESCRIPTION

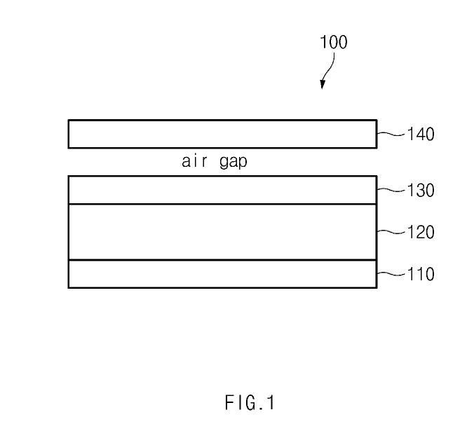

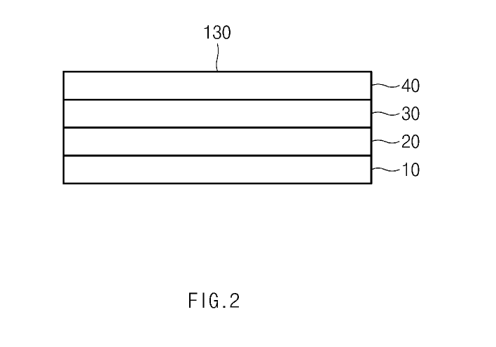

FIGS. 1 and 2, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged display apparatus.

FIG. 1 is a diagram schematically illustrating a structure of a display apparatus according to an embodiment of the present disclosure.

Referring to FIG. 1, a display apparatus 100 includes a first polarizer 110, a liquid crystal panel 120, a second polarizer 130, and a touch panel 140.

The first polarizer 110 and the second polarizer 130 can divisionally transmit or interrupt a vertical or horizontal polarized wave of incident light.

In certain embodiments, the liquid crystal panel 120 is placed between the first polarizer 110 and the second polarizer 130. The liquid crystal panel 120 includes a liquid crystal material between glass substrates and orientations of the liquid crystal material can change based on whether a voltage is applied to an electrode. The liquid crystal panel 120 can be prepared with a type that is generally used in the art.

In certain embodiments, the touch panel 140 is placed on the top of the second polarizer 130. An air gap can be between the second polarizer 130 and the touch panel 140. The touch panel 140 can be prepared with a type that is generally used in the art.

FIG. 2 is a diagram schematically illustrating a structure of a second polarizer according to an embodiment of the present disclosure.

Referring to FIG. 2, the second polarizer 130 includes a first protection film 10, a polarization film 20, a second protection film 30, and an antiglare film 40.

The first protection film 10 can be placed under the polarization film 20 and attached to the polarization film 20. The second protection film 30 can be placed on the polarization film 20 and attached to the polarization film 20. In certain embodiments, the first protection film 10 and the second protection film 30 are films attached respectively to the top and bottom of the polarization film 20 and protecting the polarization film 20 and are formed of a material which is superior in transparence, mechanical strength, thermal stability, moisture shielding property, isotropy, and so forth.

The first protection film 10 or the second protection film 30 can be a film formed of a thermoplastic resin, for example, polyester resin such as polyethylene terephthalate, polyethylene isophthalate, or polybutylene terephthalate; cellulose resin such as diacethyl cellulose, or triacethyl cellulose; polycarbonate resin; acrylic resin such as polymethyl (meta)acrylate, or polymethyl (meta)acrylate; styrene resin such as polystyrene, acrylonitrile-styrene copolymer; polyethylene resin; polyprophylene resin; polyolefin resin having cyclo-based or norbornene structure; polyolefin resin such as ethylene prophylene copolymer; vinylchloride resin; polyamide resin such as nylon, or aromatic polyamide; imid resin; polyether sulfonic resin; sulfonic resin; polyether ketonic resin; polyphenylene sulfide resin; vinyl alcoholic resin; vynylidene chloride resin; vinyl butyral resin; alylate resin; polyoxymethylene resin; or epoxy resin, or a film formed of a blended material of thermoplastic resins. Additionally, it may be even permissible to use a film made of a thermosetting resin such as (meta)acrylic resin, urethane resin, or silicon resin, or a ultra-violet setting resin. It is preferred, among them, to adopt triacetyl cellulose film, cycloolefin film, polyethylene terephthalate film, or polymethyl metacrylate film.

The polarization film 20 can be placed between the first protection film 10 and the second protection film 30. The polarization film 20 can divisionally transmit or interrupt a vertical or horizontal wave of incident light. A film, which is generally used in the art, can be used as the polarization film 20. For example, a polyvinyl alcoholic film can be used as the polarization film 20.

The antiglare film 40 can be placed on the top of the second protection film 30. For example, the antiglare film 40 can be attached to (coated on) the front (i.e., the surface facing the touch panel 140 of the display apparatus).

The antiglare film 40 may act as a layer that is directly in contact with the touch film and directly affects generation of a watermark. Generation of a watermark can be affected from a haze value and an arithmetic mean deviation of the profile (Ra). As a haze value and an arithmetic mean deviation of the profile of the antiglare film 40 become relatively higher, the watermark is reduced. However, if a haze value and an arithmetic mean deviation of the profile of the antiglare film 40 increase to prevent a watermark, a sparkling may occur. To prevent both the watermark and the sparkling, it can be important to use the antiglare film 40 that has appropriate haze and arithmetic mean deviation of the profile. A haze value or arithmetic mean deviation of the profile of the antiglare film 40 can be variable according to a shape, size, and amount of silica grains.

The antiglare film 40 according to an embodiment of the present disclosure includes a haze value of 3 to 5% and has an arithmetic mean deviation of the profile (Ra) of 60 to 100 nm. If a haze value of the antiglare film 40 is less than 3% or an arithmetic mean deviation of the profile of the antiglare film 40 is less than 60 nm, a watermark can occur to result in degradation of visibility. If a haze value of the antiglare film 40 is larger than 5% or an arithmetic mean deviation of the profile of the antiglare film 40 is larger than 100 nm, a sparkling can occur to result in degradation of visibility.

The antiglare film 40 can have a haze value of 3 to 4% and an arithmetic mean deviation of the profile of 60 to 80 nm. If a haze value of the antiglare film 40 is 3 to 4% and an arithmetic mean deviation of the profile of the antiglare film 40 is 60 to 80 nm, the watermark and sparkling do not occur, thereby improving visibility and anti-glare characteristic.

The aforementioned haze value and arithmetic mean deviation of the profile of the antiglare film 40 are used in the case that a display (or liquid crystal panel) with the second polarizer 130 is less than 250 pixels per inch (ppi). In the case that the liquid crystal panel 140 is larger than 250 ppi, visibility can be degraded due to interference between pixels of the liquid crystal panel 140 and the second polarizer 130.

In the case that the liquid crystal panel 140 is larger than 250 ppi, a haze value of the antiglare film 40 can be 0.5 to 1% and an arithmetic mean deviation of the profile of the antiglare film 40 can be 30 to 60 nm.

According to an embodiment of the present disclosure, the polarizer 130 can further include an adhesive layer for attaching the polarizer 140 to the liquid crystal panel 120. The adhesive layer is placed on the bottom surface of the first protection film 10 and then can attach the second polarizer 130 to the liquid crystal panel 120.

An adhesive layer can be formed by using a decompressed adhesive. A decompressed adhesive can be prepared with one, which is generally used in the art, without limitation. For example, a decompressed adhesive can be one selected from acrylic, rubber, urethane, silicon, and polyvinyl ether groups, especially, an acrylic group, which is superior in optical transparence and adhesiveness.

In one illustrative example, a haze value and arithmetic mean deviation of the profile of an antiglare film manufactured according to various embodiments and comparisons of the present disclosure were measured, and results of evaluating sparkling and watermark of a display apparatus with the antiglare film are shown in Table 1.

1. Haze measurement

A haze of a polarizer manufactured through embodiments and comparisons was measured by using a hazemeter NDH-2000 of Denshoku Co.

2. Arithmetic mean deviation of the profile measurement

An arithmetic mean deviation of the profile manufactured through embodiments and comparisons was measured by setting 1000 magnifications through a 3D microscope.

3. Sparkling measurement

After attaching a polarizer, which was manufactured through embodiments and comparisons, through a transparent adhesive to a liquid crystal panel having 4.19 inches, WVGA (480×800) of resolution, and 223 ppi, a touch panel treated for anti-reflection (AR) was installed, with an air gap of 0.25 mm from the polarizer interposed therebetween.

In evaluating sparkling, whether the sparkling occurs was observed in the vertical direction (0°) to the touch panel at a distance of 30 cm from the touch panel after marking a white image on the liquid crystal panel.

◯: No sparkling

ΔΔ: Very small sparkling

Δ: Small sparkling

X: Distinct sparkling

4. Watermark evaluation

After attaching a polarizer, which was manufactured through embodiments and comparisons, through a transparent adhesive to a liquid crystal panel having WVGA (480×800) of resolution and 223 ppi, a touch panel treated for anti-reflection (AR) was installed, with an air gap of 0.25 mm from the polarizer interposed therebetween.

In evaluating front visibility, a watermark was observed in the vertical direction (0°) by pressing the center of the touch panel through two thumbs.

In evaluating side visibility, a watermark was observed in a side direction (45°) by pressing the center of the touch panel through two thumbs.

◯: No watermark

ΔΔ: Very small watermark

Δ: Small watermark

X: Distinct watermark

In evaluating reliability, the center of the touch panel was pressed by an iron rod in weight from first 600 g/f until 100 g/f, a watermark was observed in the vertical direction of the touch panel, and thereby first watermark weight was measured.

TABLE 1

| | | | | Watermark Evaluation | | |
|---|---|---|---|---|---|---|
| | | | | | | Reliability |
| | Haze | Ra | Sparkling | | | Evaluation |
| | (%) | (nm) | Evaluation | Front | Side | (kg/f) |
| Comparison 1 | 0.2 | 35 | ◯ | Δ | X | 0.7 |
| Comparison 2 | 0.6 | 50 | ◯ | X | X | 0.7 |
| Comparison 3 | 3.4 | 56 | ◯ | Δ | X | 0.8 |
| Embodiment 1 | 3 | 61 | ◯ | ΔΔ | Δ | 0.8 |
| Embodiment 2 | 3 | 70 | ◯ | ◯ | Δ | 0.8 |
| Embodiment 3 | 4 | 75 | ΔΔ | ◯ | Δ | 0.9 |
| Embodiment 4 | 5 | 80 | ΔΔ | ◯ | Δ | 0.9 |
| Comparison 4 | 24 | 154 | X | ◯ | Δ | 1.0 |
| Comparison 5 | 26 | 79 | X | ◯ | Δ | 0.8 |
| Comparison 6 | 27 | 87 | X | ◯ | Δ | 0.8 |

Referring to Table 1, it is apparent that a display apparatus with an antiglare film according to various embodiments of the present disclosure is superior in protecting sparkling and watermark effects.

A polarizer according to various embodiments of the present disclosure is formed to prevent watermark and sparkling and to improve visibility. Additionally, the watermark can be diminished to scale down an air gap between a polarizer and a touch panel and to reduce a thickness of a display apparatus.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A polarizer comprising:
a polarization film;
a first protection film attached to a bottom surface of the polarization film;
a second protection film attached to a top surface of the polarization film; and
an antiglare film formed on a top surface of the second protection film,
wherein the antiglare film has a haze value in 3 to 5% and an arithmetic mean deviation of the profile (Ra) of 60 to 100 nm.

2. The polarizer of claim 1, wherein the antiglare film comprises a haze value in 3 to 4% and an arithmetic mean deviation of the profile (Ra) of 60 to 80 nm.

3. The polarizer of claim 1, wherein the polarizer is adapted to be attached to a display apparatus.

4. The polarizer of claim 1, wherein at least one of the first protection film or second protection film comprises one of:
a thermoplastic resin, polyester resin, polyethylene terephthalate, polyethylene isophthalate, polybutylene terephthalate, cellulose resin, diacethyl cellulose, triacethyl cellulose, polycarbonate resin, acrylic resin, polymethyl (meta)acrylate, polymethyl (meta)acrylate, styrene resin, polystyrene, acrylonitrile-styrene copolymer, polyethylene resin, polyprophylene resin, polyolefin resin having cyclo-based or norbornene structure, polyolefin resin, ethylene prophylene copolymer, vinylchloride resin, polyamide resin, nylon, aromatic polyamide, imid resin, polyether sulfonic resin, sulfonic resin, polyether ketonic resin, polyphenylene sulfide resin, vinyl alcoholic resin, vynylidene chloride resin, vinyl butyral resin, alylate resin, polyoxymethylene resin, epoxy resin, or a film formed of a blended material of thermoplastic resins.

5. A display apparatus comprising:
a liquid crystal panel;
a first polarizer attached to a bottom surface of the liquid crystal panel;
a second polarizer attached to a top surface of the liquid crystal panel; and
a touch panel disposed apart from a top surface of the second polarizer,
wherein the second polarizer comprises:
a polarization film;
a first protection film attached to a bottom surface of the polarization film;
a second protection film attached to a top surface of the polarization film; and
an antiglare film formed on a top surface of the second protection film,
wherein the antiglare film has a haze value in 3 to 5% and an arithmetic mean deviation of the profile (Ra) of 60 to 100 nm.

6. The display apparatus of claim 5, wherein the antiglare film has a haze value in 3 to 4% and an arithmetic mean deviation of the profile (Ra) of 60 to 80 nm.

7. The display apparatus of claim 5, wherein the liquid crystal panel is less than 250 pixels per inch (ppi).

8. The display apparatus of claim 5, wherein at least one of the first protection film or second protection film comprises one of:
a thermoplastic resin, polyester resin, polyethylene terephthalate, polyethylene isophthalate, polybutylene terephthalate, cellulose resin, diacethyl cellulose, triacethyl cellulose, polycarbonate resin, acrylic resin, polymethyl (meta)acrylate, polymethyl (meta)acrylate, styrene resin, polystyrene, acrylonitrile-styrene copolymer, polyethylene resin, polyprophylene resin, polyolefin resin having cyclo-based or norbornene structure, polyolefin resin, ethylene prophylene copolymer, vinylchloride resin, polyamide resin, nylon, aromatic polyamide, imid resin, polyether sulfonic resin, sulfonic resin, polyether ketonic resin, polyphenylene sulfide resin, vinyl alcoholic resin, vynylidene chloride resin, vinyl butyral resin, alylate resin, polyoxymethylene resin, epoxy resin, or a film formed of a blended material of thermoplastic resins.

9. A portable electronic device comprising:
a processor coupled to a liquid crystal panel;
a first polarizer attached to a bottom surface of the liquid crystal panel;
a second polarizer attached to a top surface of the liquid crystal panel; and
a touch panel disposed apart from a top surface of the second polarizer,
wherein the second polarizer comprises:
a polarization film;
a first protection film attached to a bottom surface of the polarization film;
a second protection film attached to a top surface of the polarization film; and
an antiglare film formed on a top surface of the second protection film,
wherein the antiglare film has a haze value in 3 to 5% and an arithmetic mean deviation of the profile (Ra) of 60 to 100 nm.

10. The portable electronic device of claim 9, wherein the antiglare film has a haze value in 3 to 4% and an arithmetic mean deviation of the profile (Ra) of 60 to 80 nm.

11. The portable electronic device of claim 9, wherein the liquid crystal panel is less than 250 pixels per inch (ppi).

12. The portable electronic device of claim 9, wherein at least one of the first protection film or second protection film comprises one of:
a thermoplastic resin, polyester resin, polyethylene terephthalate, polyethylene isophthalate, polybutylene terephthalate, cellulose resin, diacethyl cellulose, triacethyl cellulose, polycarbonate resin, acrylic resin, polymethyl (meta)acrylate, polymethyl (meta)acrylate, styrene resin, polystyrene, acrylonitrile-styrene copolymer, polyethylene resin, polyprophylene resin, polyolefin resin having cyclo-based or norbornene structure, polyolefin resin, ethylene prophylene copolymer, vinylchloride resin, polyamide resin, nylon, aromatic polyamide, imid resin, polyether sulfonic resin, sulfonic resin, polyether ketonic resin, polyphenylene sulfide resin, vinyl alcoholic resin, vynylidene chloride resin, vinyl butyral resin, alylate resin, polyoxymethylene resin, epoxy resin, or a film formed of a blended material of thermoplastic resins.
